(19) United States
(12) Patent Application Publication
(10) Pub. No.: US 2012/0027562 A1
(43) Pub. Date: Feb. 2, 2012

(54) MACHINE SYSTEM AND METHOD FOR TRANSFERRING AND GROUPING ARTICLES AND PACKAGING MACHINE

(75) Inventors: Marco POCATERRA, Ferrara (IT); Andrea ZECCHINI, Bologna (IT)

(73) Assignee: CT PACK S.R.L., Crespellano (Bologna) (IT)

(21) Appl. No.: 13/193,781

(22) Filed: Jul. 29, 2011

(30) Foreign Application Priority Data
Jul. 30, 2010 (IT) BO2010A000490

(51) Int. Cl. B65G 47/30; B65G 57/02; B65G 37/00

(52) U.S. Cl. 414/802; 198/418.7

(57) ABSTRACT

A system (1) for transferring and grouping articles (A), in particular food articles (A) having a mainly flat extension, comprises: a feed line (LB), designed to feed a flow of articles (A); a station (20) for picking up the articles (A) from the feed line (LB) and for grouping the articles (A) picked up, designed to group a predetermined number of articles (A) and to form groups (G); a transfer unit (24) which picks up and transfers the groups (G) from the pickup and grouping station (20) to a station (22) for releasing the groups (G) to an outfeed line (LU) and which comprises first pickup means (49) for the groups (G), the outfeed line (LU) comprising second pickup means (50) for transferring sequences of the groups (G) of articles (A) to a packaging station (46); a control and actuator unit (51) designed to receive as input a signal (S1) from the outfeed line (LU) indicating a cyclical sequence of the positions for picking up the groups (G) of articles (A) which are gradually reached by the second pickup means (50) relative to the first pickup means (49), the control and actuator unit (51) being designed to send as output a signal (S2), subject to the signal (S1), for activating the transfer unit (24) in such a way as to allow the performance, according to a well-defined step, of the transfer of the groups of articles from the first pick up means (49) to the second pickup means (50).

This application claims priority to Italian Patent Application BO2010A000490 filed Jul. 30, 2010, the entirety of which is incorporated by reference herein.

This invention relates to a system and a method for transferring and grouping articles, in particular food articles which have a mainly flat extension.

The invention also relates to an automatic machine for packaging articles which comprises the same system for transferring articles.

In the food industry there are various prior art system for transferring and grouping articles for packaging purposes.

For example, patent EP0709289 in the name of Cavanna S.p.A. describes a system for transferring articles and forming stacks of articles in a plant for the automatic packaging of food products.

The device comprises a multi-way system for transferring articles, that is to say, using two or more transfer lines.

Associated with each transfer line there is a loading hopper in which the articles are positioned in stacks.

Moreover, each transfer line comprises a pusher designed to cyclically push a set of articles which are positioned at the bottom of the stack, and a conveyor unit comprising a plurality of contact elements, known to experts in the field as “flights”, which transfer the set of articles, fed by the pusher, along a substantially straight path.

In said transfer system the transfer lines release the articles to an outfeed conveyor extending at a right angle to the transfer lines.

Each transfer line releases the articles to an outfeed conveyor at its own release region and at a predetermined release height, both different to those of the other lines. That layout of the transfer lines and that height offset between the lines means that the various sets of articles released by the transfer lines are superposed in the outfeed conveyor, thus forming a stack of articles, made up of sets of articles from different transfer lines.

The stack of articles is designed to be inserted, downstream of the outfeed conveyor, in a corresponding package.

One disadvantage of that transfer and grouping system is that it cannot guarantee sufficient reliability.

If one of the pushers of the transfer lines feeds an incorrect number of articles (for example more or less than a predetermined number), the transfer and grouping system performs incorrect stacking of the articles at the outfeed conveyor which, in the most serious cases, causes the machine to stop and in any case produces, at outfeed, packages with an incorrect number of articles in them.

Moreover, the transfer device is quite complex, in particular requiring many adjustments for change-over, due to the presence of a plurality of transfer lines whose plan layout and height must be suitably adjusted.

Therefore, the aim of this invention is to propose a system and a method for transferring and grouping articles which are simple and reliable and which overcome the above-mentioned disadvantages.

Another aim of this invention is to propose a machine for packaging articles which is simple and highly reliable.

Accordingly, this invention achieves that aim with a system and a method for transferring and grouping comprising the technical features described in the appended claims.

The technical features of the invention, with reference to the above aims, are clearly described in the claims below and its advantages are more apparent from the detailed description which follows, with reference to the accompanying drawings which illustrate a preferred embodiment of the invention provided merely by way of example without restricting the scope of the inventive concept, and in which:

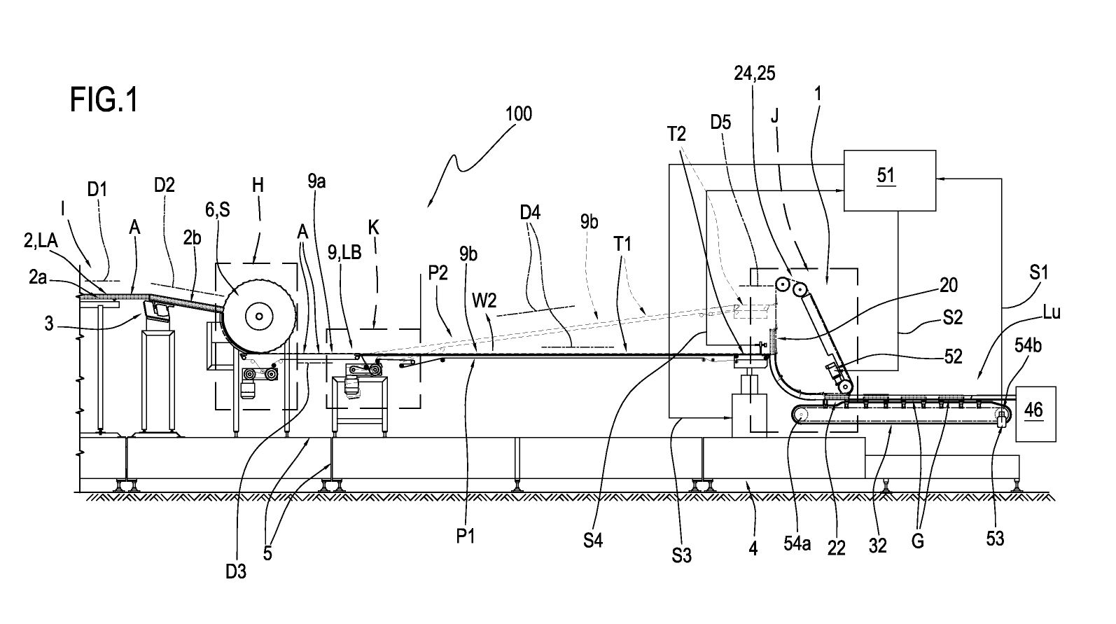

FIG. 1 is a side view of a packaging machine comprising a system for transferring articles in accordance with this invention;

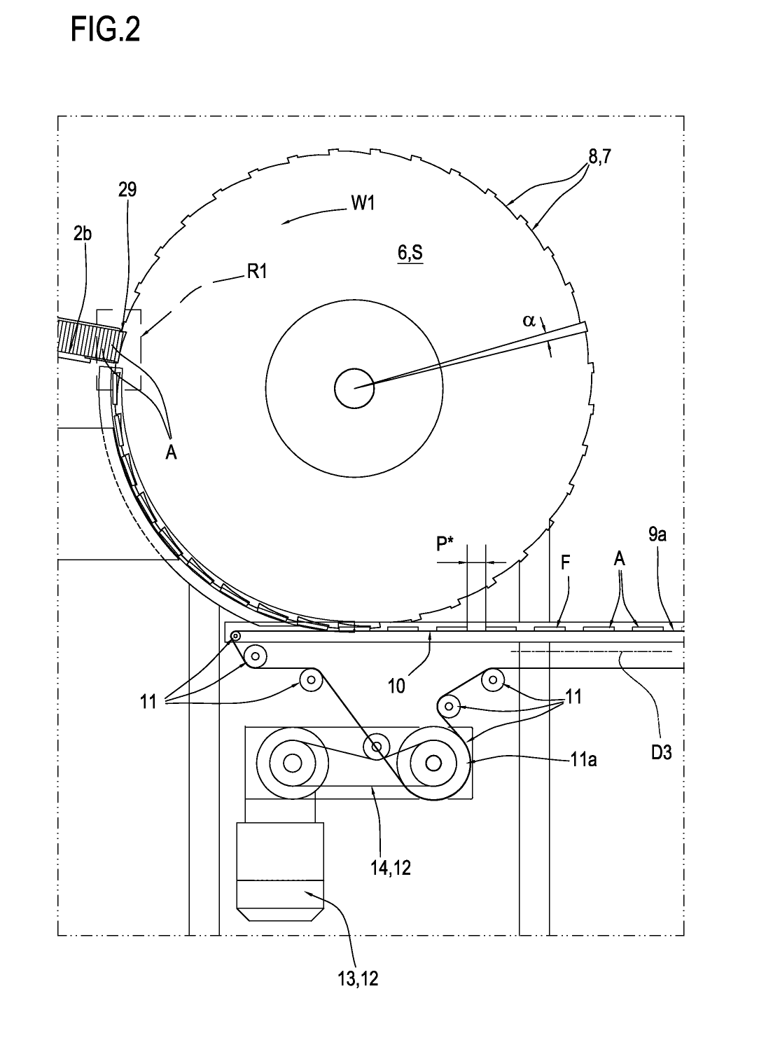

FIG. 2 is an enlarged side view of a detail H of the machine of FIG. 1;

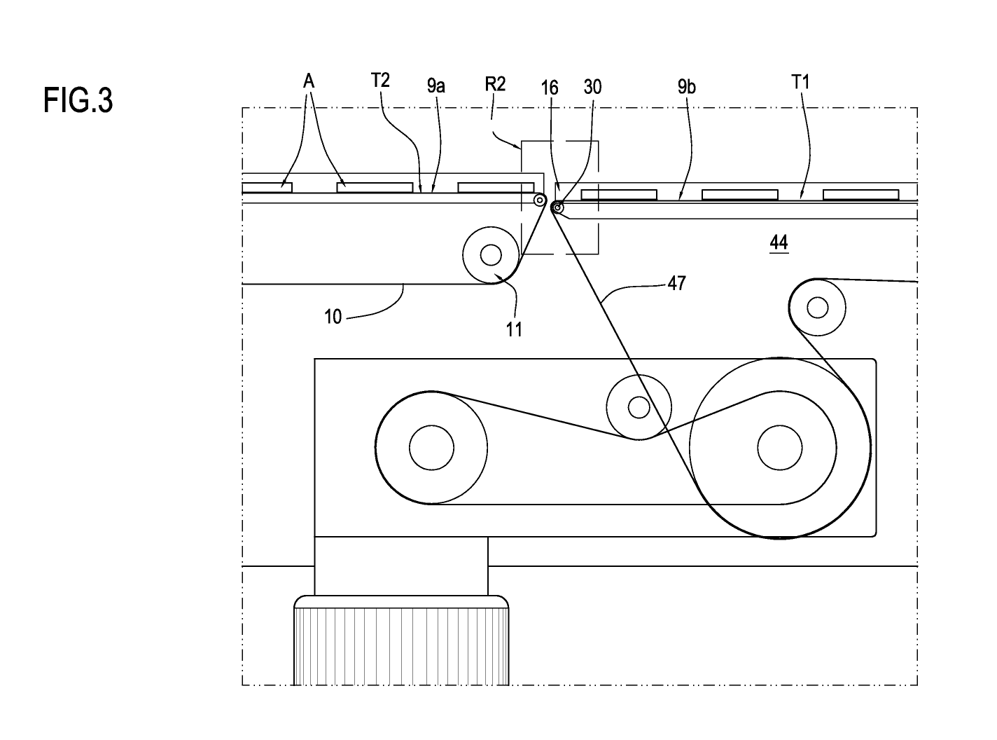

FIG. 3 is an enlarged side view of another detail K of the machine of FIG. 1;

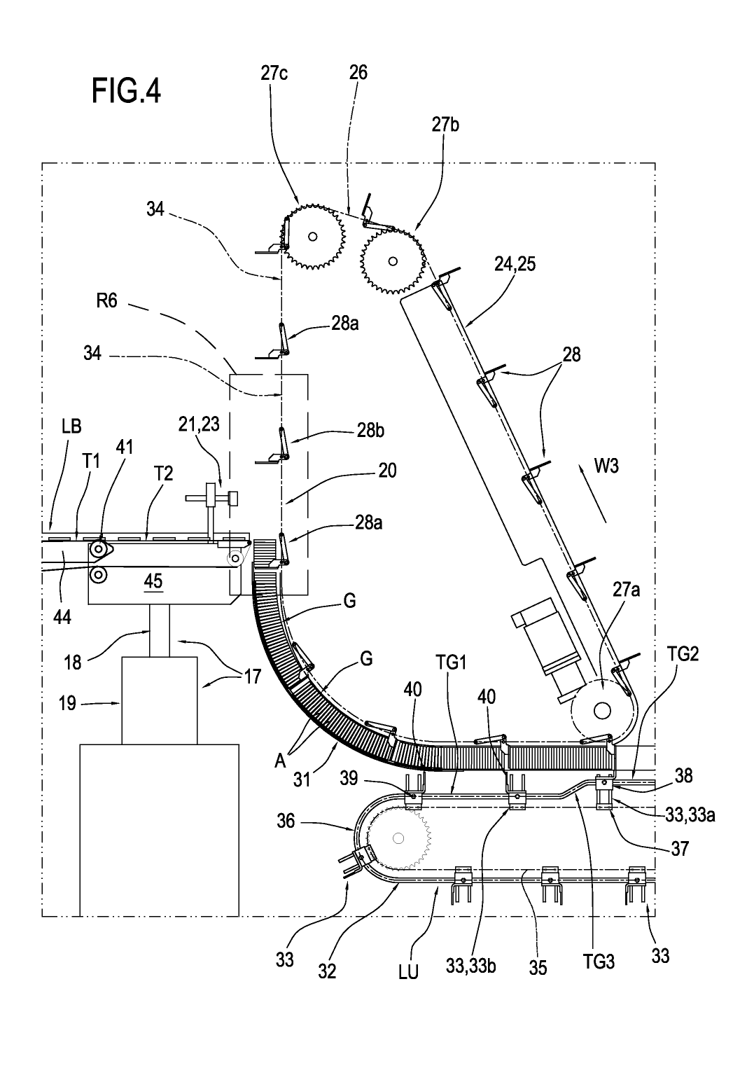

FIG. 4 is an enlarged side view of yet another detail J of the machine of FIG. 1;

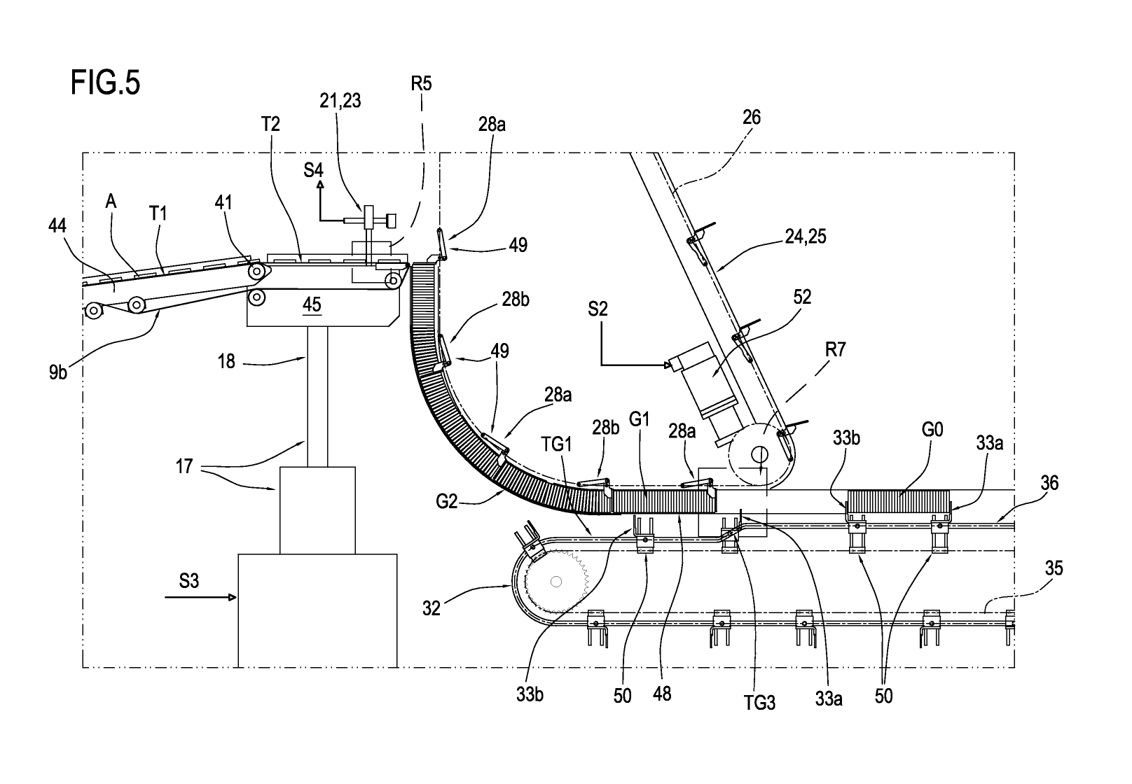

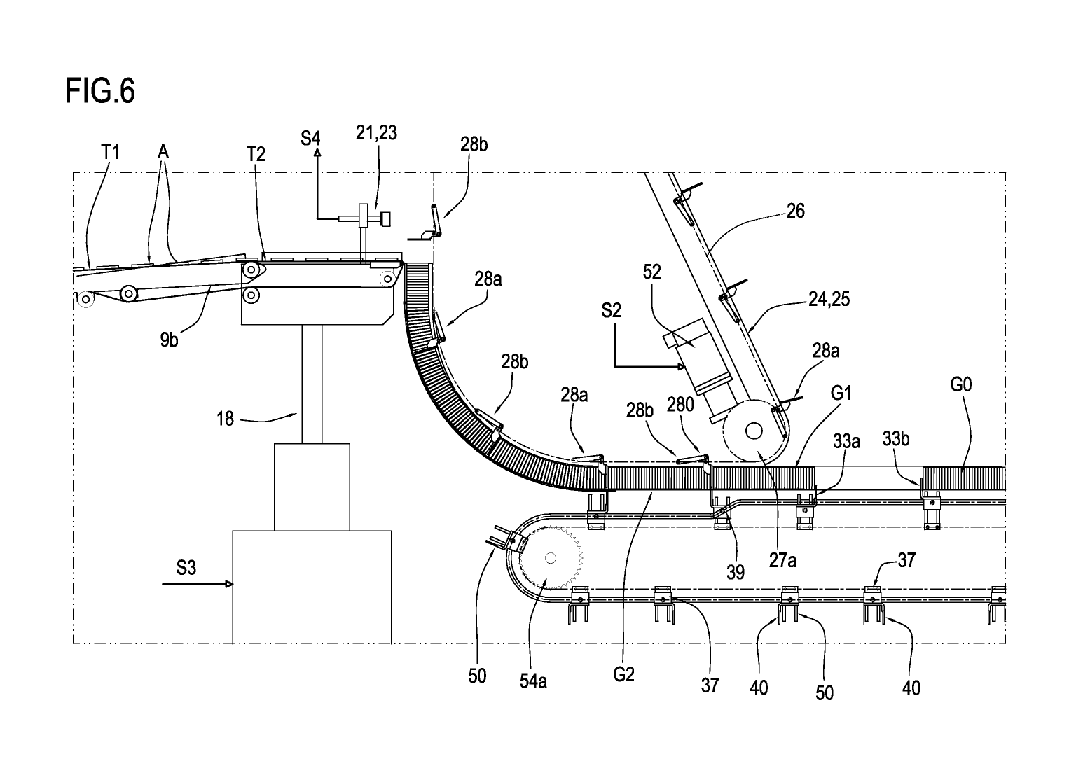

FIGS. 5 and 6 illustrate respective side views of a detail of the machine of FIG. 1 in as many configurations;

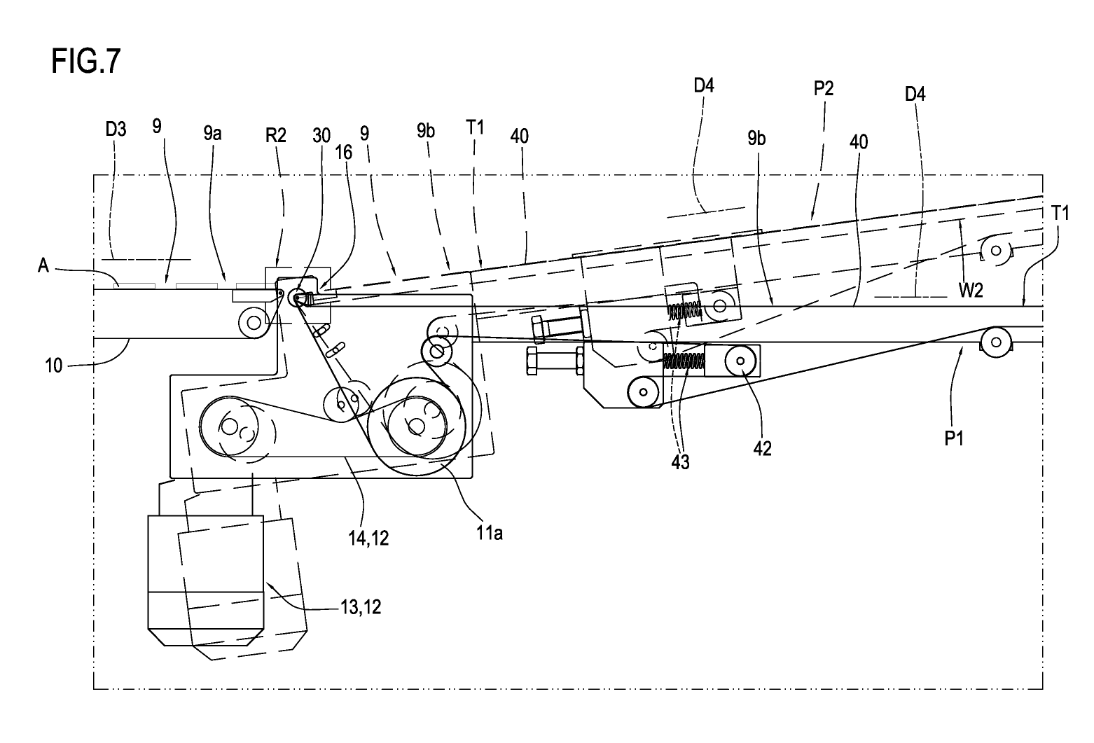

FIG. 7 is an enlarged side view of a detail of the machine of FIG. 1.

With reference to the accompanying drawings, the numeral 100 denotes a machine for packaging articles A, in accordance with this invention, and the numeral 1 denotes a system for transferring and grouping articles A also in accordance with this invention.

In particular, the machine 100 is designed to package articles A which have a mainly flat extension, preferably food articles such as crackers.

The following is a description, by way of example only and without limiting the scope of the invention, of the packaging machine 100 in its entirety. The description also indicates the advantages and technical—functional features of the transferring and grouping system 1 integrated in it.

It should be noticed that the transferring and grouping system 1 advantageously can also be associated with, that is to say, can be integrated in, other types of machines.

Therefore, in light of this, again it should be noticed that the example described below is provided by way of example only, without in any way limiting the scope of the invention.

The machine 100 is described below relative to the flow of articles A through it, that is to say, from the infeed I to the outfeed U of the machine 100.

The machine 100 comprises a frame 4, designed to support the elements and parts of which the machine 1 consists, described in more detail below.

The frame 4 preferably comprises a plurality of tubular elements 5 which are interconnected in such a way as to create a supporting structure.

According to the invention, the machine comprises a vibrating channel 2 forming a channel LA for accumulation of articles A.

In particular and without limiting the scope of the invention, the vibrating channel 2 comprises a first stretch 2a and a second stretch 2b.

The first stretch 2a is preferably substantially horizontal.

The first stretch 2a is designed to feed the articles A in a direction of feed labelled D1, whilst the second stretch 2b is set at an angle to the first stretch and is designed to feed the articles in a direction of feed labelled D2.

The vibrating channel 2 comprises respective actuator means 3 designed to make the channel 2 vibrate. The actuator means 3 are of the known type and therefore are not described in detail.

Preferably, as is clearly shown in FIG. 1, the articles A are fed along the vibrating channel 2 in contact with each other.

Said feed arrangement is also referred to in this description as “on edge”, this expression meaning that the articles A are arranged in such a way that the faces F of the articles A with the largest flat extension are in contact with each other and the articles are fed in a direction that is perpendicular to the plane in which said faces F extend.

According to the invention, the machine 100 comprises a wheel 6, clearly visible in FIG. 2, designed to pick up articles A from the vibrating channel 2.

In light of this, it should be noticed that, in the example illustrated, the wheel 6 is positioned at the end 29 of the second stretch 2b of the vibrating channel.

The wheel 6 comprises a plurality of recesses 8 extending radially which form corresponding cavities 7 designed to receive the articles A.

It should be noticed that each cavity 7 is shaped to hold one article A.

According to the invention, the wheel 6 is designed to pick up one article at a time from the vibrating channel 2, at the region labelled R1 in FIG. 2.

The wheel 6 is made to rotate, in the direction of rotation labelled W1 in FIG. 2, by respective actuator means (not illustrated).

The cavities 7 are preferably spaced in such a way that they are separated from each other by an angle α. This allows the articles A to be spaced along the outside of the wheel 6 by a predetermined distance which depends, according to a known geometric relationship, on the diameter of the wheel 6 and the angle α.

The machine 100 also comprises a conveyor unit 9.

The conveyor unit 9 is designed to receive the articles from the wheel 6.

The conveyor unit 9 preferably comprises a first belt conveyor 9a, positioned to receive articles from the wheel 6, and a second belt conveyor 9b positioned to receive articles from the first belt conveyor 9a.

The conveyor unit 9 in its entirety forms a feed line LB for a flow of articles A.

By way of example and without limiting the scope of the invention, the articles are conveyed along the feed line LB one after another, in such a way as to form a flow of articles A.

In particular, it should be noticed that the articles A are positioned with the face F having the largest flat extension in contact with the surface of the upper branches of the belts of the belt conveyors 9a and 9b.

The first conveyor 9a of the conveyor unit 9 is designed to receive the articles A from the wheel 6, as is clearly shown in FIG. 2.

The wheel 6 releases the articles A onto the upper branch of the belt 10 of the first conveyor 9a, spacing them at a predetermined spacing P* (in a geometric relationship with the angle α and with the diameter of the wheel 6).

It should be noticed that, in accordance with the invention, the wheel 6 forms a device S which is operatively positioned between the accumulation channel LA and the feed line LB for picking up articles A one at a time from the accumulation channel LA and releasing them to the feed line LB according to a predetermined spacing P*.

The belt 10 of the first conveyor 9a is trained around a plurality of pulleys, labelled 11.

One of the pulleys 11, individually labelled 11a, is connected to the actuator means 12 for the belt 10 so that it can be rotationally driven. The other pulleys 11 are preferably of the idle type.

The actuator means 12 for the pulley 11a preferably comprise a motor 13 and a belt 14 connecting the motor to the pulley 11a.

As is clearly visible in FIG. 3 the first conveyor 9a transfers the articles A in the direction labelled D3.

Preferably, according to the invention, the direction D3 is parallel with the direction D1.

With reference to FIG. 3, R2 denotes the transfer region where the first conveyor 9a releases the articles to the second conveyor 9b.

The second conveyor 9b is preferably a belt conveyor, comprising an endless belt 47.

The second conveyor 9b comprises, along the direction of feed for the articles A, a first portion 44 and a second portion 45 connected to each other by an articulated joint 41, for allowing variation of the relative angular position of a first stretch T1 and a second stretch T2 of upper branch of the belt 40 associated with those portions 44, 45.

In particular, it should be noticed that the first stretch T1 is associated with the first portion 44 and the second stretch T2 is associated with the second portion 45.

Known means, not described in detail herein, keep constant the overall length of the upper branch of the belt 40 of the second conveyor 9b, that is to say, the sum of the stretches T1 and T2, lengthening or shortening one of the lower branches of the belt according to the relative angular position of the first stretch T1 and the second stretch T2 of the upper branch. That allows the tension on the belt 40 of the second conveyor 9b to be kept constant, avoiding excessive tensioning or loosening.

It should be noticed that the second conveyor 9b comprises a mobile pulley, individually labelled 42, which is connected by a spring 43 to the first portion 44 which rotatably supports all of the other pulleys.

The pulley 42 and the spring 43 form means for maintaining a predetermined tension of the belt 40 of the second conveyor 9b.

The first portion 44 of the second conveyor 9b is rotatably supported by the frame 4.

In particular, FIG. 3 shows how the first portion 44 is hinged to the frame 4 in such a way that the first stretch T1 of the upper branch of the belt is free to rotate relative to the point labelled 30.

In particular, the first stretch T1 is designed to rotate between two limit positions, respectively a lowered position P1 (illustrated in FIG. 1) and a raised position P2 (illustrated with a dashed line in FIG. 1 and which, from the lowered position P1 of FIG. 1 and with reference to FIG. 1, is reached by means of a rotation in the direction labelled W2).

The pivot point 30 is positioned at the end 16 of the second conveyor 9b close to the region R2 where the articles A are transferred from the first conveyor 9a to the second conveyor 9b.

It should be noticed that in the raised position P2 (shown with a dashed line in FIG. 1) the first stretch T1 of the upper branch of the second conveyor 9b is inclined at an angle to a horizontal line.

As is clearly shown in FIG. 4, the second stretch T2 of the second conveyor 9b is connected to a slider 18 which can move vertically (clearly visible in FIG. 4) to allow movement of the second stretch T2 between two limit positions, respectively lowered and raised.

The slider 18 is driven by actuator elements schematically illustrated and labelled 19 as a whole.

The slider 18 and actuator means 19 assembly forms means 17 for moving the first and second stretches (T1, T2) of the upper branch of the belt 47 of the second conveyor 9b between the two limit positions P1 and P2.

In particular, it should be noticed that the second conveyor 9b is designed in such a way that the slider 18 maintains unchanged the angle of the conveying direction D5 of the second stretch T2 relative to a horizontal plane. In other words, the angle of the second stretch T2 relative to a horizontal plane is kept unchanged, irrespective of the position adopted by the slider 18, whilst the angle of the first stretch T1 relative to a horizontal plane depends on the position adopted by the slider 18.

In other words, the conveying direction D4 of the first stretch T1 is modified, varying the angle relative to a horizontal plane, depending on the position of the slider 18.

Therefore, the second conveyor 9b can release the articles A at a plurality of different heights for releasing the articles A.

Advantageously, the second conveyor 9b is able to convey the articles in such a way that on the second stretch T2 they are positioned substantially with the face F having the largest flat extension lying in a horizontal plane. That advantageous technical feature is described in more detail below, with reference to machine 100 operation.

According to the invention, the machine 100 comprises a sensor 21 designed to detect the passage of the articles along the feed line LB.

The sensor preferably detects the passage of the articles A at a detection region R5 positioned on the second stretch T2 of the belt 47 of the conveyor 9b.

The sensor 21 forms means 23 for counting the articles A along the feed line LB.

The machine 100 also comprises a station 20 for picking up and grouping the articles A, designed to pick up individual articles A from the feed line LB and to group them together.

The pickup and grouping station 20 is designed to pick up the articles A from the feed line LB and to group the articles A in such a way as to form groups G of articles A consisting of a predetermined number of articles A.

It should be noticed that, preferably, the groups G consist of the same number of articles A.

Hereinafter the groups G of articles A are also referred to using the term “groups”.

In particular, the station 20 for picking up and grouping the articles A is designed to stack the articles A.

As illustrated in FIG. 5, the articles A are positioned at the pickup and grouping station 20 in such a way as to form a vertical stack of articles A, that is to say, the articles are superposed one on top of another.

According to the invention, the machine 100 also comprises a unit 24 for transferring the groups G, set up to transfer the groups G from the pickup and grouping station 20 to a station 22 for releasing the groups G to an outfeed line LU, which is also part of the machine 100.

It should be noticed that, in the embodiment illustrated, the pickup and grouping station 20 is formed at a region R6 of the transfer unit 24.

In particular, the transfer unit 24 forms the pickup and grouping station 20 at the region labelled R6.

According to the embodiment illustrated in the accompanying drawings, the transfer unit 24 is a conveyor unit 25 of the chain type.

The conveyor unit 25 comprises a pair of chains 26, schematically illustrated in the accompanying drawings, trained around corresponding gear wheels (27a, 27b, 27c) and positioned side by side.

At least one 27a of the gear wheels (27a, 27b, 27c) is rotationally driven by actuator means 52.

Each chain 26 is equipped with a plurality of contact and support elements 28 for the articles A, which are connected to the chain 26 and project towards the outside of the chain 26.

According to the invention, the contact elements 28 more generally form first means 49 for picking up the groups G of articles.

Hereinafter the contact elements 28 are also referred to as contacts 28.

It should be noticed that the contact elements 28 of the chains 26 form housings 34 for groups G of articles A.

In particular, the contact elements of the first chain 26 are labelled 28a and the contact elements of the second chain 26 are labelled 28b.

In particular, by way of example and without limiting the scope of the invention, a group G is placed in a housing 34 formed by a contact element 28a of one of the two chains 26 and by a contact element 28b of the other of the two chains.

The fact that there are two chains 26 whose contact elements 28 operate in conjunction with each other to form the housings 34 for the groups G advantageously allows the transfer unit 24 to be rapidly and simply adapted for transferring groups G consisting of any number of articles A. The two chains 26 can be appropriately synchronised with each other in their direction of extension in such a way as to regulate, as required, the housing 34 space formed by the contact elements 28 of the two chains 26.

The two chains 26 are preferably synchronised, that is to say, positioned relative to each other along their direction of extension, according to the methods described below:
in accordance with a first synchronisation method, the contact elements 28a and 28b of the two chains 26 are aligned, along the direction of extension of the chains 26, to form a housing 34 space with maximum amplitude for the groups G of articles A;
in accordance with a second synchronisation method (illustrated in FIG. 4) the contact elements 28a and 28b are suitably offset along the direction of extension of the chains 26 in such a way as to form housings 34 with minimum amplitude which are identical, the minimum amplitude corresponding to around half of the maximum amplitude.

It should be noticed, with reference to the example in FIG. 4, that a stack of articles A forming a group G is supported by one of the contact elements 28a (positioned downstream relative to the direction of feed W3 of the chains 26) of one of the two chains 26, whilst a contact element 28b of the other chain 26 (positioned upstream relative to the direction of feed W3 of the chains 26) acts as an element delimiting the housing 34 and is designed to support the next group G.

According to an alternative embodiment not illustrated in the accompanying drawings, the conveyor unit 25 comprises a single endless chain 26, equipped with a plurality of contact and support elements 28 for the articles A which form the housings 34 for the groups G.

In accordance with said alternative embodiment, a group G of articles A is intended to occupy the housing 34 made available by a pair of adjacent contact elements 28 along the endless path on which the chain 26 extends, according to methods similar to those described above.

The conveyor unit 25 is set up to release the groups G of articles A at a releasing station, labelled 22 and more clearly visible in FIG. 4.

The conveyor unit 25 also comprises a guide 31.

According to the example illustrated, the guide 31 is fixed to the frame 4.

The guide 31 allows the groups G of articles A to be guided along a path for conveying the groups G formed by the conveyor unit 25 between the pickup and grouping station 20 and the releasing station 22. Therefore, the guide 31 prevents the articles A from falling as the articles A are transferred from the pickup station 20 to the releasing station 22.

Moreover, it should be noticed that the conveyor unit 25 transfers the groups G from the pickup and grouping station 20, in which they are stacked vertically, and releases them at the releasing station 22 in an “on edge” arrangement.

In light of this, it should again be noticed that the conveyor unit 25 transfers the groups G according to a direction of feed on edge.

The machine 100 outfeed line LB comprises, by way of example and without limiting the scope of the invention, a conveyor 32 of the type with a chain 35.

The chain 35 forms an endless path between a pair of gear wheels (54a, 54b), of which one gear wheel 54b is driven by respective actuator means 53.

The conveyor unit 32 also comprises a guide 36, associated with it, extending on the outside of the endless path formed by the chain 35.

The guide 36 preferably extends in such a way as to form an endless path.

The top of the guide 36 comprises a first stretch TG1, a second stretch TG2 and a third stretch TG3 connecting the first stretch TG1 and the second stretch TG2.

The stretches TG1, TG2, TG3 are preferably straight.

Even more preferably, the third, connecting stretch TG3 is a stretch inclined at an angle to a horizontal plane.

The conveyor unit 32 also comprises a plurality of contact elements 33 for the groups G of articles A.

According to the invention and more generally, the contact element 33 form second means 50 for picking up the groups G of articles.

The contact elements 33 form a space for housing a group G of articles.

In particular, the conveyor unit 32 alternatively comprises a front contact element 33a, designed to make contact with the front of a group G of articles, that is to say, to delimit the front of the housing space, and a rear contact element 33b, designed to make contact with the back of a group G of articles A, that is to say, to delimit the back of the housing space.

The following is a description of a preferred embodiment of the contact elements 33. It should be noticed that said embodiment is shown purely by way of example and the contact elements 33 could have any structure/shape even different to that described, without departing from the protective scope of this description.

Each contact element 33 comprises a first portion 37, fixed to the chain 35, and a second portion 38 able to move relative to the first portion 37.

According to the embodiment illustrated, the second, mobile portion 38 comprises means 39 for connecting to the guide 36.

Therefore, more generally the second portion 38 is constrained to move along the path formed by the guide 36.

Moreover, the second portion 38 comprises a projecting prong 40 designed to make contact with the group G of articles A.

It should be noticed that each group G of articles A, when it has been released by the conveyor unit 25, is housed in a housing formed by a pair of contact elements (33a, 33b), respectively upstream and downstream with reference to the direction of feed of the groups Gin the outfeed line LU.

In this regard, it should be noticed that the outfeed line LU preferably transfers the groups G of articles on edge.

It should be noticed that the feed line LB, the pickup and grouping station 20, the transfer unit 24, the releasing station 22 and the outfeed line LU together form the system 1 for transferring and grouping articles A in accordance with this invention.

Preferably, downstream of the outfeed line LU, the machine 100 comprises a packaging station (schematically illustrated in FIG. 1 and labelled 46) where the groups G of articles A are inserted in respective containers or sealed with flexible wrappers made of plastic material.

According to the invention, the machine 100 also comprises a control and actuator unit 51, hereinafter referred to as the control unit 51, which is connected to the conveyor unit 32 of the outfeed line LU and to the transfer unit 24.

Moreover, preferably, the control unit 51 is also connected to the sensor 21 and to the feed line LB, in particular to the movement means 17 of the second conveyor 9b.

Below is a description of packaging machine 100 operation with reference to the packaging of a group G of articles A.

The sequence of steps described below is illustrated in FIGS. 5 and 6 which represent, by way of example, a preferred method of operation of the machine.

It shall be understood, from the following description, that the machine 100 and in particular the transfer system 1 may be operated, according to the invention, even in accordance with methods other than those described.

The wheel 6, rotationally driven in the direction of rotation W1, cyclically picks up individual articles A and releases them to the first conveyor 9a which in turn releases them to the second conveyor 9b.

FIGS. 2 and 3 show how the conveyors 9a and 9b convey an orderly flow of articles A (that is to say, a flow of articles A spaced at a constant spacing P*). However, that does not limit the scope of the invention, since according to the invention the articles could also be fed randomly or with variable spacing.

The sensor 21 counts the number of articles A passing along the feed line LB and sends a corresponding signal S4 to the control unit 51.

The control unit 51 drives, that is to say, activates, the actuator means 19 for the slider 18 of the second conveyor 9b by means of an output signal S3 according to the methods described below.

In light of this, it should be noticed that, with each article A detected by the sensor 21 passing in the detection region R5, the second stretch T2 of the second conveyor 9b is moved upwards by a distance corresponding at least to the thickness of one article A, in such a way as to allow the articles A to be stacked, forming the group G.

It should be noticed that from the signal S4 the control unit 51 is able to count the number of articles A inserted in the housing 34, that is to say, released from the feed line LB, and the number of articles A which still need to be inserted in order to complete the group G.

FIG. 5 shows a machine 100 configuration in which a group G has been completed in the housing 34 of the conveyor unit 25 at the pickup and grouping station 20.

In FIG. 5, the control unit 51 has already activated movement of the conveyor unit 25 in such a way that it is suitably synchronised with the outfeed line LU.

It should be noticed how the control unit 51 has already sent an output signal S2 to the actuator means 52 for the conveyor unit 25.

The signal S2 is a signal for activating the conveyor unit 25.

It should be noticed how, in general, the control unit 51 activates the movement of the conveyor unit 25—by means of the signal S2—subject to a signal S1 input into the control unit 51 and arriving from the outfeed line LU.

The signal S1 is a signal indicating a cyclical sequence of the positions for picking up the groups G of articles A which are gradually reached by the second pickup means 50 relative to the first pickup means 49.

That idea is explained in more detail below.

In other words, it should be noticed that, during the movement of the conveyor unit 32, the second pickup means 50 (that is to say, the contact elements 33a and 33b) move to a pickup position relative to the first pickup means 49.

During a complete rotation of the conveyor unit 32, each pair of contact elements, front 33a and rear 33b, forming the second pickup means 50, is located, relative to the first pickup means 49, in a position for picking up the group G in which the control unit sends the signal S3 for activating the actuators 52 for the conveyor unit 25.

The fact that the conveyor unit 32 comprises a plurality of pairs of front and rear contact elements 33a, 33b, each forming the second pickup means 50, in general means that in a complete rotation of the chain 35 of the conveyor unit 32 there is a sequence of pickup positions which are gradually reached by each pair of contact elements 33a, 33b—that is to say, second pickup means 50—present on the conveyor 32.

Therefore, preferably, the signal S1 from the outfeed line is a signal of the ON/OFF type which adopts the ON value when one of the individual pickup devices 50 has reached a pickup position relative to the first pickup means 49.

According to an alternative embodiment, the signal S1 is a signal indicating the position of one of the two gear wheels 54a, 54b, for example deriving from an encoder.

Preferably, if the conveyor unit 32 is operated at a constant speed, the signal S1 is a cyclical signal.

To better illustrate that idea, it is assumed that the conveyor unit 25 is immobile, that is to say, not activated.

The passage of one of the front contact elements 33a at a predetermined position relative to the contact elements 28 which retain the group G1 at the releasing station 22, causes activation of the conveyor unit 25 which, from that moment, begins moving in such a way that it is suitably synchronised with the conveyor unit 32.

In that sense, in light of the above, it is clear how the signal S2 is subject to the signal S1.

From the moment it is activated, the conveyor unit 25 is controlled in such a way that it is in a phase relation with the conveyor 32, that is to say, the speed of the conveyor unit 25—or more generally the speed profile of the conveyor unit 25—is a predetermined relation with the speed of the conveyor 32—or more generally with the speed profile of the conveyor 32.

This allows a group G of articles to be released by the first pickup means 49 to the second pickup means 50 according to a well-defined step.

In general the conveyor unit 25 is activated with constant steps, that is to say, at each activation cycle of the conveyor unit 25, each contact element 28, when the conveyor is stopped, occupies the position that was previously occupied, before the activation cycle, by the contact element 28 now located downstream relative to the direction of feed W3 of the conveyor unit 25.

With reference to the specific example illustrated in FIGS. 5 and 6, the control unit 51 activates the conveyor unit 25 when a front contact element 33a of the conveyor 32 is passing in the third, angled stretch TG3 of the upper branch of the guide 36.

It should be noticed that when the front contact element 33a of the conveyor 32 passes in the angled stretch TG3 the projecting prong 40 is positioned at a height greater than that of the surface 48 on which the articles A rest.

Activation of the conveyor unit 25 therefore allows the group labelled G1 to follow the front contact element 33a of the conveyor 32 in such a way that the first article A of the group G1 is brought into contact with the front contact element 33a of the conveyor 32.

It should be noticed that at the region labelled R7 the front contact element 33a of the conveyor 32 makes contact with the first article of the group G1 and the contact element 28a of the conveyor unit 25 abandons contact with the first article. In that region R7 there is no interference between the front contact element 33a and the contact element 28a, since the contact elements (33a, 28a) are suitably shaped relative to each other.

By way of example and without limiting the scope of the invention, according to a front view, the contact element 28a, 28b of the conveyor unit 25 has two prongs and has the shape of an inverted U. This allows the projecting prong 40 to be inserted in the recess formed by the inverted U, at the region R7, without any interference between the contact elements 33a, 28a and 28b.

The conveyor unit 25 is suitably driven in such a way that it is synchronised with the outfeed line LU so that, at the angled stretch TG3 of the guide 36, the rear contact element 33b of the conveyor is inserted in the space between the two groups (see FIG. 6) labelled G1 and G2. In particular, it is inserted at the contact element 28 which for clarity is individually labelled 280.

As a result of engagement of the rear contact element 33b of the conveyor 32 with the group G1, the conveyor 32 feeds the group G1 forwards.

The operations described above by way of example form a step of releasing a group G from the first pickup means 49 to the second pickup means 50.

It should be noticed that once the release operation is complete, the control unit 51 can disable the conveyor unit 25.

The cycle for transferring a group G from the conveyor unit 25 to the conveyor 32 is repeated in the manner according to the methods described above, for the next group of articles (that is to say, for the group G2 in FIG. 5).

It should be noticed that the second stretch T2 of the conveyor 9b is moved vertically according to detection of the passage of an article A in the detection zone R5 and according to the movement of the conveyor unit 25.

According to said aspect, when the conveyor unit 25 is moved to release the group G to the outfeed line LU, the second stretch T2 is moved downwards to follow the movement of the housing 34 and so that the articles A arriving can be inserted in the housing in the correct position.

Moreover, the second stretch T2 is moved vertically upwards according to the increase in the articles A detected by the sensor 21, that is to say, arriving towards the pickup and grouping station 20.

It should be noticed that the upward vertical movement of the second stretch T2 is a motion for stacking the articles A, performed as an article A passes in the zone R5 for detection of the passage of an article A by the sensor 21.

Therefore, the second stretch T2 is moved according to a law of motion comprising a downward vertical movement following the conveyor unit 25—preferably continuous—and an upward vertical movement, that is to say, opposite to the previous movement,—which is usually intermittent.

More generally, the movement of the second stretch 9b resulting from overlapping the downward vertical following movement and the stacking vertical movement is preferably a movement of the continuous type with variable speed.

It should be noticed that the two vertical movements may or may not be combined (that is to say, one of the two movements may not be performed, for example because no articles A arrive along the feed line LB or because the conveyor unit 25 is not operated).

In general, the second stretch T2 is moved according to the signal S4, that is to say, due to an increase in the count of articles A, and the signal S2, which indicates the movement of the conveyor unit 25.

Therefore, more generally, the second stretch T2 is moved according to the arrival of an article A in the pickup and grouping station 20 and according to the movement of the conveyor unit 25.

The following are some general considerations regarding the machine 100 and the transfer system 1.

It should be noticed that, in the absence of articles A, that is to say, groups G in the housings 34 of the conveyor unit 25, the conveyor unit 25 preferably is not moved.

According to an operating method not illustrated, the conveyor 32 of the outfeed line LU may be operated according to any law of motion, that is to say, even at a speed that is not constant. In accordance with that embodiment, the conveyor unit 25 is activated and moved with a corresponding law of motion in such a way that it is possible to release at a predetermined step the groups G from the first pickup means 49 of the conveyor 25 to the second pickup means 50 of the outfeed line LU according to the methods described above.

The advantage of this invention is apparent from the above description.

According to the invention, the transfer system 1 allows the articles to be transferred from an infeed line LB to an outfeed line LU, simultaneously grouping the articles A.

Advantageously, the outfeed line may be operated using any law of motion (obviously, provided that the speeds of the outfeed line LU allow, depending on the release rate of articles A from the feed line LB to the conveyor unit 25, the transfer of the groups of articles A between the line LB and the outfeed line LU).

Moreover, according to another advantageous aspect of the invention, the transfer system 1 allows a situation in which it can be guaranteed that each group G will consist of precisely the predetermined number of articles A.

According to an alternative embodiment, not illustrated in the accompanying drawings, the conveyor unit 25 is designed to transfer containers to the pickup and grouping station 20.

In accordance with that alternative embodiment, the articles A are stacked directly in a container at the grouping and pickup station and are transferred to the releasing station 22 in the container.

The invention described above is susceptible of industrial application and may be modified and adapted in several ways without thereby departing from the scope of the inventive concept. Moreover, all details of the invention may be substituted by technically equivalent elements.

1. A system (1) for transferring and grouping articles (A), comprising:
a feed line (LB), designed to feed a flow of articles (A);
a station (20) for picking up articles (A) from the feed line (LB) and for grouping the articles (A) picked up, designed to group together a predetermined number of articles (A) in groups (G);
a unit (24) for picking up and transferring the groups (G), comprising first pickup means (49) for the groups (G), and designed to transfer the groups (G) from the pickup and transfer station (20) to a station (22) for releasing the groups (G) to an outfeed line (LU); the outfeed line (LU) comprising second pickup means (50) for transferring groups (G) of articles (A) one after another to a packaging station (46); the system being characterised in that it comprises a control and actuator unit (51) designed to receive as input a signal (S1) arriving from the outfeed line (LU) and indicating a cyclical sequence of the pickup positions for the groups (G) of articles (A), these positions being gradually reached by the second pickup means (50) relative to the first pickup means (49), the control and actuator unit (51) being designed to send as output a signal (S2), subject to the signal (S1), for activating the transfer unit (24) in such a way as to be able to perform, according to a well-defined step and synchronised with the cyclical sequence, the respective transfer of the groups of articles from the first pickup means (49) to the second pickup means (50).

2. The system according to claim 1, characterised in that the feed line (LB) for the articles (A) comprises a portion (9b) able to move vertically for releasing the articles (A) to the pickup and grouping station (20) at a plurality of releasing heights, the control unit (51) being designed to send as output a signal (S3) for vertical movement of the mobile portion (9b), the output signal (S3) being subject to the signal (S2) for activating the transfer unit (24).

3. The system according to claim 2, characterised in that it comprises means (23) for counting the articles (A) along the feed line (LB), which are connected to the control unit (51) for sending to the latter a signal (S4) relating to the passage of an article (A) in a predetermined region (R5) along the feed line (LB) and also being characterised in that the control unit (51) is programmed to send the vertical movement signal (S3) partly also on the signal (S4) indicating the passage of an article (A).

4. The system according to claim 2, characterised in that the mobile portion (9b) comprises, relative to the direction of feed of the articles (A), respectively a first stretch (T1), attached to the frame (4) in an articulated fashion, and a second stretch (T2) connected to the first stretch (T1) in an articulated fashion.

5. The system according to claim 4, characterised in that the mobile portion (9b) is designed in such a way that the second stretch (T2) is positioned in the same way irrespective of the release height for the articles (A).

6. The system according to claim 3, characterised in that the control unit (51) is programmed to issue the command for an upward movement of the mobile portion (9b) according to an increase in the count and it is also programmed to issue the command for a downward vertical movement of the mobile portion (9b) according to activation of the transfer unit (24).

7. The system according to claim 1, characterised in that the transfer unit (24) comprises an endless conveyor unit (25) and the first pickup means (49) comprise a plurality of contact elements (28) which are fixed to the conveyor unit (25).

8. The system according to claim 1, characterised in that the outfeed line (LU) comprises an endless conveyor (32) and the second pickup means (50) comprise a plurality of contact elements (33) which are fixed to the conveyor (32).

9. The system according to claim 1, characterised in that the conveyor unit (25) is designed to transfer the groups (G) of articles in such a way that they are arranged on edge.

10. A machine (100) for packaging articles (A), in particular for packaging food articles (A) having a mainly flat extension, characterised in that it comprises:
a channel (LA) for accumulation of the articles (A);
a transferring and grouping system (1) according to any of the foregoing claims;
a device (S) operatively positioned between the accumulation channel (LA) and the feed line (LB) and for picking up individual articles (A) from the accumulation channel (LA) and releasing them individually to the feed line (LB).

11. The machine according to claim 10, characterised in that the device (S) comprises a wheel (6) the outside of which is equipped with a plurality of cavities (7), each cavity (7) being designed to house one article (A), the wheel (6) being rotationally driven to allow said pick up and releasing of the articles (A).

12. The machine according to claim 11, characterised in that the cavities (7) are spaced in such a way that they release the articles (A) with a predetermined spacing (P*).

13. The machine according to claim 10, characterised in that the articles are arranged on edge in the accumulation channel (LA).

14. A method for transferring articles (A) from a feed line (LA) to an outfeed line (LB) and for grouping the articles (A), comprising the following steps:
feeding a flow of articles (A) along a feed line (LB) to a pickup and grouping station (20) for the articles (A);
stacking the articles (A) at the pickup and grouping station (20) to form a group (G) of articles (A) comprising a predetermined number of articles (A),
transferring, by means of a transfer unit (24) equipped with first pickup means (49), the group (G) from the pickup and grouping station (20) to a station (22) for releasing the groups to a conveyor (32) of the outfeed line (LU) equipped with second pickup means (50),
the method being characterised in that it also comprises the following step:
releasing the group (G) from the first pickup means (49) to the second pickup means (50) at the releasing station (22), the transfer of the group (G) from the pickup and grouping station (20) to the releasing station (22) being activated according to a signal (S1) indicating a cyclical sequence of pickup positions for the groups (G) of articles (A), these positions being gradually reached by the second pickup means (50) relative to the first pickup means (49), and the transfer being then performed in such a way as to allow said release according to a well-defined step synchronised with the cyclical sequence.

15. The method according to claim 14, characterised in that the stacking step comprises a step of vertically moving at least one portion (9b) of the feed line (LB) for releasing the articles (A) to the pickup and grouping station (20) at various releasing heights.

16. The method according to claim 15, comprising a further step of counting the articles fed along the feed line (LB).

17. The method according to claim 16, comprising a step of counting the articles (A) upstream of the pickup and grouping station (20) and in which the vertical movement of at least one portion (9b) of the feed line (LB) is performed in a direction for stacking the articles (A) according to an increase in the count and in a direction opposite to the stacking direction during implementation of the step of transferring the group (G) from the pickup and grouping station (20) to the releasing station (22).
